(19) United States
(12) Patent Application Publication
(10) Pub. No.: US 2004/0020278 A1
(43) Pub. Date: Feb. 5, 2004

(54) Erosion monitoring of ceramic insulation or shield with wide area electrical grids

(76) Inventors: Gordon Bryce McGarvey, Sarnia (CA); Lorne G. Powell, Corunna (CA)

Correspondence Address: ExxonMobil Research and Engineering Company, (formerly Exxon Research and Engineering Company), P.O. Box 900, Annandale, NJ, 08801-0900, US

(21) Appl. No.: 10/209,350

(22) Filed: Jul. 31, 2002

(51) Int. Cl. G01N 17/00

(52) U.S. Cl. 73/86

(57) ABSTRACT

Detecting erosion of refractory thermal insulation or a ceramic shield over a wide area is achieved by monitoring an electrical property of at least one wide area, planar, electrically conductive grid through which a current flows. The grid is located in or under the insulation or shield, with the grid plane and parallel to its hot or impact face, preferably over at least two square feet. When erosion erodes part of the grid, the electrical property changes and indicates that erosion has reached the grid.

### BACKGROUND OF THE DISCLOSURE

1. Field of the Invention

The invention relates to wide area detection and monitoring of the erosion of a ceramic shield or insulation exposed to a hot environment, using wide area electrical grids. More particularly the invention relates to detecting and monitoring the erosion of a ceramic shield or thermal insulation over a wide area in a hot process vessel, with at least one wide area electrical grid which comprises at least one electrically conductive wire or rod and which substantially follows the contour of the hot or impact face of the insulation or shield in or under which it is disposed.

2. Background of the Invention

Most furnaces and many chemical process vessels, such as coker scrubbers, high temperature chemical reactors, vessels containing molten metal and the like, contain thermal insulating material disposed against, or proximate to, at least a portion of the interior surface of the vessel, in which the combustion, reaction or other process occurs. The thermal insulating material is typically fabricated of refractory metal oxide ceramic and prevents creeping, softening, melting and/or rapid erosion of the vessel wall, which is typically made of steel. Erosion of the insulation typically occurs as a result of one or more fluid streams flowing in the vessel and proceeds much more rapidly if the flowing stream contains solid particulate matter, such as particles of coke, catalyst, combustion ash and the like. Monitoring the erosion is necessary to protect the steel wall of the vessel from being eroded and breached. Erosion detecting and monitoring devices typically comprise a plurality of separate and discrete electrical wires or closed end gas conduits, imbedded in the insulation. The longitudinal axes of the gas conduits are typically aligned in a direction radially and/or perpendicularly disposed from the interior surface of the vessel wall, inwardly towards the interior of the vessel. Wire detectors typically extend over less than two or three inches parallel to the surface of the insulation. When the insulation or shield is eroded down to the wire or the gas conduit, it cuts the wire or makes a hole in the conduit. This produces an open circuit or change in pressure, which is detected and causes a signal to be sent to an alarm or control panel, indicating that insulation erosion has reached that point. This enables an operator or computer to change the operating conditions of the unit to reduce the erosion rate or to schedule a shutdown for repair of the insulation, before catastrophic erosion or melting through the vessel wall can occur. U.S. Pat. Nos. 3,898,366; 4,248,809; 4,442,706; 4,655,077; 5,566,626 and 5,740,861 disclose typical methods and means used for monitoring erosion of a shield or insulation lining the interior of a hot process vessel.

Only a relatively small cross-sectional area of the insulation parallel to the inner wall surface of the vessel is monitored by each probe and erosion must occur uniformly across the insulation where the probes are placed, for the monitoring to be effective. The wires are typically contained in a probe or lance, which is limited to monitoring a small area. This requires a plurality of probes to cover a wide area, at a given depth in the insulation. Each probe must have associated with it (i) means for detecting a change in pressure, current, resistance, etc., and (ii) means for sending a signal indicative of such change to (iii) means for indicating and recording the change, and insuring that any required action be taken as a consequence of the detected erosion. Each probe in the vessel is typically connected, through a hole in the exterior wall of the vessel, to a hermetically sealed packing gland known as a nozzle, and then to signal and recording means outside the vessel. If the pressure in the vessel is different from ambient, the nozzle must include at least one pressure barrier. The nozzle is attached to the outer surface of the vessel wall over the hole and, for a hot vessel, must also be resistant to high temperature. In addition to cost, each nozzle requires a significant amount of space on the exterior vessel wall surface. Each hole compromises the integrity of the wall. The space requirements for the nozzles and the danger to the integrity of the vessel wall integrity limit the number of probes that can be used. Therefore, a method of monitoring erosion over a wide area is needed.

### SUMMARY OF THE INVENTION

The invention relates to monitoring an electrical property of at least one wide area grid comprising one or more electrically conductive wires or rods through which a current flows, for detecting erosion and monitoring the erosion rate over a wide area of a refractory ceramic shield or thermal insulation. In the process of the invention, the shield or insulation will typically be in a hot environment such as, for example, a furnace, reactor or other process vessel. More particularly the invention relates to a method for detecting and monitoring erosion of a ceramic shield or thermal insulation over a wide area in a vessel, by monitoring an electrical property of at least one relatively planar, wide area grid, the plane of which substantially follows the contour of the surface of the insulation or shield in or under which it is disposed, that is subject to erosion and wherein the grid comprises at least one electrically conductive wire or rod. When erosion reaches the grid, it erodes through the wire or rod and the electrical property changes. The change in electrical property is detected and indicates that erosion has progressed through the shield or insulation to where the grid is located. The term “grid” as used herein is employed in its ordinary sense and refers to a plurality of substantially parallel sections of electrically conductive wire or rod arrayed in the plane of the grid, as is explained in detail below. The grid may be fabricated from one or more wires or rods in electrical communication. A source of electricity applies a voltage to the grid, so that a current flows through it and the electrical property being monitored will typically be the electrical continuity of the grid. The continuity can be monitored by one or more of, current flowing through the grid, its resistance or impedance. Thus the grid is electrically connected to a source of electricity and a continuity monitor exterior of the vessel. In a typical embodiment in which the shield or insulation is in a closed environment, such as in a vessel, at least one pair of electrically conductive wires or rods electrically connected to the grid and which may or may not be a part of the it, extend from it to or through a hole in the vessel and into a nozzle exterior of the vessel, where electrical connection is made to a wire or rod in or external of the nozzle and to a monitor which monitors and detects changes in an electrical property of the grid. This change is typically recorded, displayed on some type of indicia, sounds an alarm and/or actuates a computer or other data processing unit, to insure that any required action be taken, as a consequence. By wide area is meant an area of at least one, preferably at least two and more preferably at least four square feet.

The grid is typically disposed in the insulation or shield at a predetermined depth and along a plane substantially parallel to the plane of that surface of the insulation or shield subject to erosion. For thermal insulation this surface is called the hot face. For an erosion shield it is referred to as the impact face. More precise erosion monitoring is possible by using more than one or grid, each located at a different distance from the hot or impact face. As the erosion reaches each grid, it erodes an opening in the wire or rod from which the grid is fabricated, the electrical property changes and this change is detected. Each grid is electrically connected to a source of electricity and a continuity monitor exterior of the vessel. Each grid is fabricated from one or more wires or rods in electrical communication, as a series of more or less parallel sections arrayed in a plane of substantially the same shape as that of the hot or impact face of the insulation or shield in which it is embedded and parallel to the face, or under which it is disposed. For a typical vessel, this plane will be arcuate, such as surface of a cylinder or sphere, but in some cases it may be flat. Both the shield and thermal insulation are ceramic, in that they comprise one or more refractory metal oxides, carbides, phosphates, carbonates, etc., which is relatively hard, brittle and resistant to high temperatures. By metal in this sense is meant to include silicon. They may also be cementatious, in that they may be formed from an aggregate mix, which contains water and is at least partially cured at ambient or slightly elevated temperature, much like ordinary cement and concrete. The term “shield” as used herein is meant to refer to one or more ceramic bodies of a limited size, which protect only that part of the interior vessel wall subject to erosion. In a hot environment the shield is also resistant to thermal erosion. A shield contains one or more grids disposed within it or under it at the surface not subject to erosion. One or more shields are disposed in the vessel at one or more particular locations subject to impact erosion, as opposed to thermal insulation, which is typically disposed more or less over the entire inner wall surface of at least a portion of the vessel.

In one embodiment, the invention relates to a method for detecting erosion of a ceramic shield or thermal insulation having an impact or hot face exposed to a hot environment, by monitoring an electrical property of at least one relatively planar, wide area erosion detecting grid, the plane of which extends over an area of at least one square foot and substantially follows the contour of the impact or hot face of the shield or insulation in or under which it is disposed, that is subject to erosion, wherein the grid comprises one or more electrically conductive wires or rods in electrical communication and through which a current flows, until erosion reaches the grid and erodes through the grid wire or rod, which changes an electrical property of the grid, and wherein the change is detected. In another embodiment the invention relates to a method for detecting and monitoring the erosion of a ceramic shield or thermal insulation having an impact or hot face exposed to a hot environment and in which is disposed at least two, relatively planar, wide area erosion detecting grids, the planes of which are substantially parallel, extend over an area of at least one square foot and substantially follow the contour of the impact or hot face where it is subject to erosion, with the grids being spaced apart and located at successively greater distances from the hot or impact face, by monitoring an electrical property of each of the grids, wherein each grid comprises one or more electrically conductive wires or rods in electrical communication and through which a current flows, until erosion reaches the grid and erodes through the grid wire or rod, which changes an electrical property of the grid, and wherein the change is detected.

### BRIEF DESCRIPTION OF THE DRAWINGS

FIGS. 1(a), 1(b) and 1(c) are respective simple schematic partial cross-sectional front, side and top views of an embodiment of the invention.

FIG. 2 illustrates a grid formed in a wire mesh screen type of configuration

FIG. 3 is a brief schematic cross-section of a coker vessel.

FIG. 4 illustrates a cyclone discharge nozzle and an erosion shield containing grids according to the invention.

FIGS. 5(a) and 5(b) briefly illustrate two embodiments of an erosion shield containing grids according to the invention.

### DETAILED DESCRIPTION

With respect to erosion resulting from impingement of a mixture of fluid (e.g., gas or liquid) and particulate matter, it is known that the conduits, nozzles, gas jets and orifices which feed such fluid streams into furnaces, reaction vessels and other process vessels can and do develop problems (e.g., localized blockage, uneven wear, etc.), that result in a nonuniform stream of the gas and particle mixture being directed onto the insulation or shield. This results in nonuniform erosion and it is not possible to predict where such localized impingement and concomitant erosion will occur. Localized erosion from particulate matter can occur in coker scrubbers, fluidized catalytic processes, burners, furnaces which generate fly ash and the like. The use of small area, or spot probes in such installations is not acceptable, since it is not known, a′ priori, where localized erosion will occur and there is therefore a need for a wide area erosion monitoring means for these applications. For example, in a coker the bottom coking section and the upper scrubbing section are connected by cyclones. Hot vapors and particulate matter from the coker section pass up through the cyclones. Each cyclone has a discharge nozzle, which discharges the hot vapors and particulate matter into the scrubbing section. A shield is disposed between the discharge nozzles and the vessel wall, to protect the wall from direct impingement and concomitant erosion by the particles. Thus, while there may be no need for thermal insulation over the interior surface of the vessel wall in the scrubber section, there is a need for a heat and erosion resistant ceramic shield between the vessel wall and the cyclone discharge nozzles.

By wide area is meant that each of the one or more grid extends over a planar area, which is preferably substantially parallel to the hot or impact face of the insulation or shield, of at least one, preferably at least two, more preferably at least four, and still more preferably at least about eight square feet. The shape of the grid may be square, oval, circular, or any other suitable polygonal or curvilinear shape, or combination thereof. While a grid comprising parallel sections of a wire or rod arrayed in the grid plane is mentioned above, if desired, a single grid may also comprise two such parallel arrays. Such a grid may also be fabricated somewhat like a wire mesh screen, in which the grid wires or rods are interlaced with each other. In this type of embodiment, it is preferred that the electrically conductive grid grid wires or rods be insulated, so as not to touch each other in the array. The wires or rods may be in the form of a coaxial cable, with the electrically conductive wire or rod, through which a current flows, being the center or core of the cable, surrounded by thermally resistant electrical insulation which, in turn, may or may not be surrounded by an outer metal jacket. The grid wire or rod may be made of soft stainless steel or any electrically conductive material able to withstand the temperature to which it will be exposed in the insulation of shield. Thus, by wire or rod is not meant to be limited to metal. The grid of the invention should be softer than the thermal insulation or shield and be able to withstand the elevated temperature it will be subjected to, inside the insulation or shield in the vessel, without melting. The grid may be fabricated from a single wire or rod or from a plurality of straight, angled and/or curvilinear sections electrically connected together and in electrical comunication, so as to be electrically conductive. The cross-section of the wire or rods from which the grid is fabricated need not be circular. In most applications a plurality of substantially similar grids will be disposed in the insulation parallel to each other and to the hot or impact face, with each located at a different distance between the hot or impact face of the insulation and the interior vessel wall, so that the progress of the insulation erosion is determined over a period of time.

Reactors, furnaces, crucibles and other hot process vessels are made of metal, which is typically steel or a steel alloy. The interior vessel wall or that portion thereof exposed to high temperature is lined with thermal insulation, to insulate the metal wall from temperatures high enough to soften or melt it. The insulation typically takes the form of one or more layers of cast, sprayed, bricked or preformed insulation, fastened to the vessel wall by means of metal anchors attached to the wall and extending into the insulation. The insulation itself typically comprises a somewhat porous aggregate of refractory oxides of metals such as magnesium, silicon, calcium, aluminum and compounds such as calcium aluminate which comprise more than one metal. Silicates, carbides, carbonates, posphates and the like are also used. Calcium aluminates and phosphates are widely used as the cement for aggregate insulation, particularly if it is formed by spraying or casting onto the vessel wall. As mentioned above, the inner surface of the insulation is exposed to the heat in the vessel's interior and is referred to as the “hot face”. It must be resistant to thermal degradation at the process conditions in the vessel. Some aggregates have good thermal insulating properties, but are not resistant to thermal degradation at very high temperatures, such as those in synthesis gas reformers, high temperature furnaces and the like. Where insulation comprising a composite of more than one layer is used, the hot face layer is typically the most resistant to thermal degradation, while the one or more underlayers are more thermally insulating, but not as thermally resistant. In such cases one or more grids are typically be positioned behind the hot or impact face layer and in the one or more softer, more thermally insulating layers not directly exposed to the hot impact conditions. In the case of vessels in which particulate erosion occurs, the hot face must be resistant to particulate and thermal erosion. This is also the case for ceramic shields, which protect a portion of the vessel wall or other structure in the vessel from particulate erosion. Ceramics having resistance to both particulate erosion and high temperature degradation are dense, hard, expensive and are typically used for the hot, impact face. The one or more grids are placed at successively increasing distances from the interior wall surface of the vessel, before or during formation of the thermal insulation in the vessel. In one embodiment, one or more erosion detecting grids of the invention may be contained in a replaceable section of insulation placed against the inner surface of the vessel wall, or at a specified distance inwardly of the wall, either before, as, or after the insulation layer(s) have been formed or placed in the vessel. This enables facile placement and replacement of the erosion detecting grids during a maintenance turn-around. This is explained in detail below and with reference to the figures.

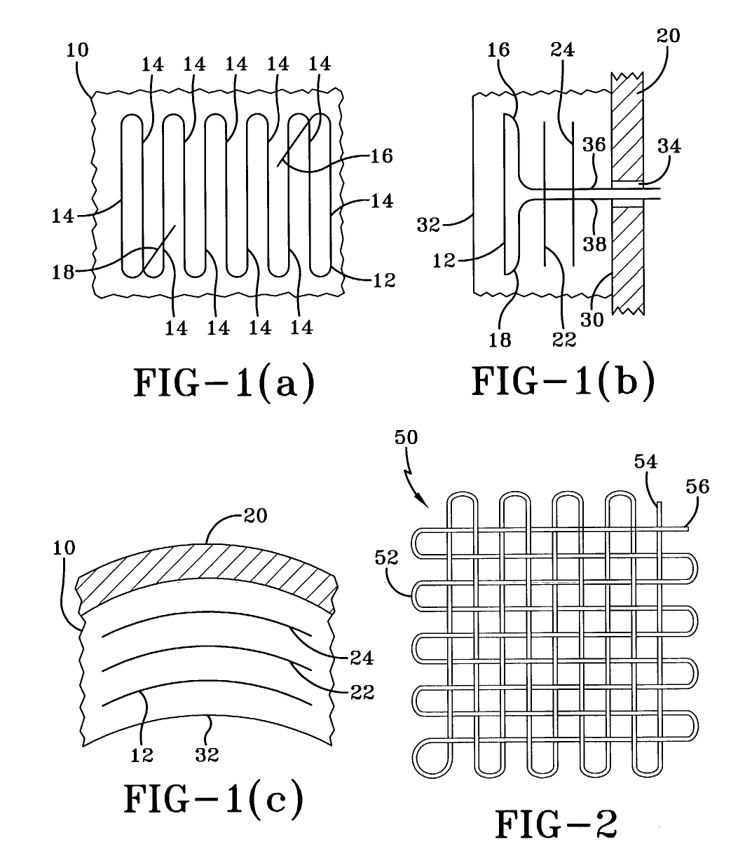

FIGS. 1(a), 1(b) and 1(c) respectively illustrate brief schematic cross-sectional front, side and top views of a section of thermal insulation in a metal vessel. Referring to FIG. 1(a), a section of refractory thermal insulation 10 is shown containing a grid 12 within. The grid comprises a single electrically conductive wire or rod or both, bent into the form of a series of elongated parallel sections 14. Both ends of the grid, 16 and 18, bend towards the vessel wall 20 and then through it as shown in FIG. 1(b), for connecting the grid to a electrical continuity monitor external of the vessel. For the sake of brevity, in this illustration only eleven parallel sections are shown. FIG. 1(b) shows two additional grids 22 and 24 identical to grid 12, disposed in the thermal insulation under grid 12. Turning now to FIG. 1(b), there is schematically depicted a vertical cross-section of a portion of the thermally insulated steel wall 20 of a process vessel or furnace. The three identical grids 12, 22 and 24, are shown disposed over each other in the insulation 10 and spaced apart at successively increasing distances from the inner surface 30 of the steel vessel wall, towards the hot face 32. Not shown are the metal anchors fastened to the inner wall of the vessel, for holding the thermal insulation in place. By way of an illustrative, but nonlimiting example, the steel vessel wall may be 1 to 2 inches thick and the thermal insulation may be 8 inches thick. Grids 12, 22 and 24 are imbedded in the insulation over each other at respective distances of 2, 4 and 6 inches from hot face 32. This enables monitoring the erosion progress over a period of time, so that process conditions can be changed to slow the erosion rate and schedule a maintenance turn-around, in which the vessel is taken off line for replacement of the insulation. While both ends of each grid pass through the hole 36 in wall 20, only ends 16 and 18 of grid 12 are shown for simplicity. Further, in the embodiment shown in FIG. 1(b), wires ends 16 and 18 are electrically connected, by welding at 40 and 42, to respective rods 36 and 38 which pass through the insulation and hole 34. Not shown is a nozzle attached to the exterior of the vessel over hole 34, for receiving both ends or the electrical connecting rods for each grid and attaching them to an external source of electricity and electrical continuity monitor (not shown), for detecting a change in an electrical property of each grid. FIG. 1(c) is a brief schematic top view of FIG. 1(a) and, like FIG. 1(b), shows the three grids 12, 22 and 24 disposed in the insulation 10. In this embodiment, the vessel wall is curved, as shown. The plane of the hot face 32 of the insulation and of the three grids 12, 22 and 24, are all parallel to each other and to the plane of the vessel wall 20. Not shown in FIG. 1(c) for simplicity are the electrical connections passing from each grid to and through the opening 34 through wall 20. FIG. 2 is a simple line drawing illustrating a grid 50, fabricated from a single wire, cable or rod 52 and formed in the general configuration of a wire mesh screen type of construction. Irrespective of the design and arrangement of the grids, the overall area coverage of the grid array should be dense enough to minimize the chances of a hole being eroded to the vessel, wall without eroding open a hole in at least one grid, yet not so dense so as to unduly reduce thermal insulation and erosion-resistance. These are intended to be illustrative, but nonlimiting examples of the invention.

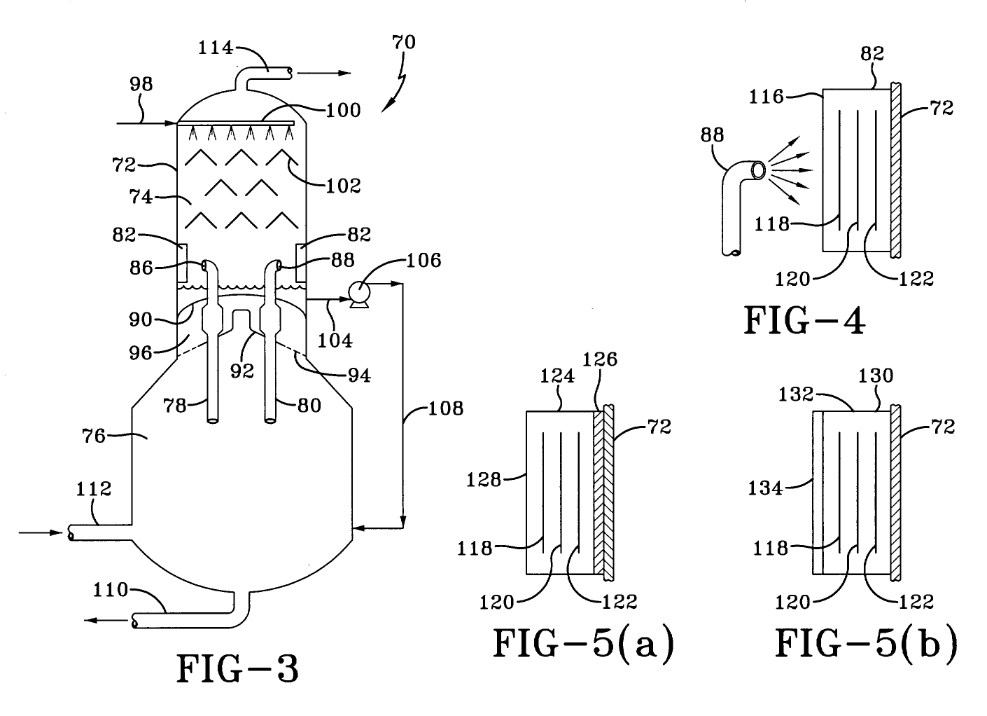

FIG. 3 is a simple cross-sectional schematic of a coker vessel which includes a scrubber. Thus coker 70 comprises a generally cylindrical vessel 72, which includes a scrubbing section 74 disposed over a coking section 76. These two sections are connected by a plurality of cyclones, of which only two, 78 and 80 are shown. Cyclones 78 and 80 each direct a hot stream, comprising hydrocarbon vapors and fine coke particles produced by the cracking reaction in 76, up into the scrubber section 74, via cyclone discharge nozzles (sometimes referred to as snouts) 86 and 88. The cyclones extend up from 76 into 74, via openings in an otherwise gas and liquid impermeable separating plate 90. A ring-shaped ceramic shield 82 is disposed against the interior wall of the vessel wall in the scrubber section 74, to prevent erosion of the vessel wall by the hot gas and particles discharged by the cyclone nozzles. Anticoking baffle 92 is permeable to gas and liquid around its periphery, as indicated by the dashed lines 94, and space 96, which contains ceramic or metal packing (not shown). The packing serves as thermal insulation between the coking and scrubbing sections. The coking vessel typically operates at about 800° F. and thermal insulation over the vessel wall is not required. However, shield 82 is required to prevent the hot discharge from the cyclones from eroding through the vessel wall opposite the nozzle openings. Thus, the ceramic shield must be resistant to erosion from the hot, coke particle-containing gas stream impinging on it. These nozzles and the cyclone discharge conduits feeding them can become partially clogged, and may also have uneven wear. This causes the discharge from the nozzle to be uneven. Therefore, the shield has to be large enough in its vertical dimension protect the vessel wall from impingement over an area greater than that normally expected from the discharge nozzles. In one actual installation, the shield is about five feet high. In operation, the heavy coker feed is passed, via feed line 98 into the top of the vessel, from where it is distributed downwardly by a plurality of spray means 100. The distributed feed oil flows down through the scrubber section 74, which contains a plurality of baffles 102 known as sheds. As the feed oil flows down, it contacts the hot oil vapors and coke particles rising up from the cyclone discharges. The hot vapors rising up through the scrubber from the snout outlets contact the liquid feed flowing down. Lighter material in the feed is stripped out and carried overhead with the vapor into the next vessel. Heavy components in the feed stream continue down through the scrubber and end up in the pool above plate 90. This liquid that collects on top of plate 90 comprises the coker feed which is withdrawn via line 104 and passed, via pump 106 and line 108, down into the coking and cracking section 76. In 76 the heavy liquid hydrocarbons contact hot (e.g., ˜1100° F.) coke particles which thermally crack a portion of the heavy, 700° F.+feed oil into lower boiling hydrocarbons and coke particles. The coke particles are withdrawn from the bottom of the coker via line 110 and passed to a regenerator (not shown) in which they are partially combusted to heat them up. The resulting hot coke particles are then fed back into the coker via line 122. The cracked and vaporized hydrocarbons boiling below about 350° F. pass up through the cyclones and scrubbing section and out the top of the coker via line 114, which passes them to further processing.

As mentioned above, the cyclone nozzles discharge into the scrubber in a direction in which the particles would impinge against the coker vessel wall, but for the protective shield 82 disposed between the flowing particles and the wall. These shields are preferably harder than typical refractory metal oxide thermal insulation used to line the walls of furnaces and process vessels, to be able to withstand the constant impingement and scouring by the hot coke particles. FIG. 4 is a brief schematic, partial side view illustrating a coker nozzle 88, discharging a hot mixture of hydrocarbon vapors and coke particles indicated by the arrows, against protective shield 82 disposed against the wall of vessel 72. For the sake of illustration, shield 82 is five feet high and, at each location opposite the discharge nozzle exits, has disposed in it three grids, 118, 120 and 122. These grids are all of a shape and disposition similar to that illustrated in FIG. 1 or 2 and each has an area of slightly less than 5″×5″, parallel to the impact face 116. Not shown for the sake of brevity, are means for anchoring the shield to the vessel wall, the nozzle and wires or rods passing through the wall, etc. Other illustrative, but non-limiting embodiments of an erosion shield containing grids according to the invention are illustrated in FIG. 5. In FIG. 5(a), a shield 124 comprises a composite of a hard, abrasion resistant refractory oxide ceramic 124, disposed on a metal backing plate 126. Three grids 118, 120 and 122 are disposed in the ceramic as in the case of FIG. 4. In this embodiment, the metal backing plate 126 of the shield 124 is fastened to the vessel wall. This provides greater resistance to cracking and breaking the integrity of the ceramic during transporting, handling and installation onto the vessel wall. Yet an other embodiment is shown in FIG. 5(b), in which the shield 130 comprises a composite of (i) a very hard and erosion resistant, sintered ceramic inner shield 134, disposed over and onto (ii) more conventional, less dense and less erosion resistant thermal insulation 132. This permits the use of a very hard sintered ceramic in combination with a less hard ceramic that, if it is sintered, is not sintered at a temperature high enough to collapse or melt of any grids disposed in it. In yet another embodiment, the composite shield of FIG. 7(b) may also include a metal backing plate, as in FIG. 7(a).

What is claimed is:

1. A method for detecting erosion of a ceramic shield or thermal insulation having an impact or hot face exposed to a hot environment, comprises monitoring an electrical property of at least one relatively planar, wide area erosion detecting grid, the plane of which extends over an area of at least one square foot and substantially follows the contour of said impact or hot face of said shield or insulation in or under which it is disposed, that is subject to erosion, wherein said grid comprises one or more electrically conductive wires or rods in electrical communication and through which a current flows, until erosion reaches said grid and erodes through said grid wire or rod, which changes an electrical property of said grid, and wherein said change is detected.

2. A method according to claim 1 wherein said grid comprises a plurality of substantially parallel sections of wire or rod arrayed in the plane of said grid.

3. A method according to claim 2 wherein said hot environment comprises the interior of a vessel.

4. A method according to claim 3 wherein said grid is electrically connected to an electrical property monitor exterior of said vessel.

5. A method according to claim 4 wherein said grid extends over an area of at least two square feet.

6. A method according to claim 5 wherein said area comprises at least four square feet.

7. A method according to claim 6 wherein said at least one grid is disposed in said shield or insulation.

8. A method according to claim 7 wherein said vessel comprises a coker and said at least one grid detects erosion of a shield therein.

9. A method for detecting and monitoring the erosion of a ceramic shield or thermal insulation having an impact or hot face exposed to a hot environment and in which is disposed at least two, relatively planar, wide area erosion detecting grids, the planes of which are substantially parallel, extend over an area of at least one square foot and substantially follow the contour of said impact or hot face where it is subject to erosion, with said grids being spaced apart and located at successively greater distances from said hot or impact face, by monitoring an electrical property of each of said grids, wherein each said grid comprises one or more electrically conductive wires or rods in electrical communication and through which a current flows, until erosion reaches a grid and erodes through said grid wire or rod, which changes an electrical property of said grid, and wherein said change is detected.

10. A method according to claim 9 wherein each said grid comprises a plurality of substantially parallel sections of wire or rod arrayed in the plane of said grid.

11. A method according to claim 10 wherein said hot environment comprises the interior of a vessel.

12 A method according to claim 11 wherein said plane of each said grid extends over an area of at least two square feet.

13. A method according to claim 12 wherein said grid is electrically connected to an electrical property monitor exterior of said vessel.

14. A method according to claim 13 wherein said area comprises at least four square feet.

15. A method according to claim 14 wherein said vessel comprises a coker and said grids detect erosion of a shield therein.

16. A method according to claim 17 wherein said shield is positioned adjacent to at least a portion of an interior wall surface of said vessel.
